(19) United States
(12) Patent Application Publication
(10) Pub. No.: US 2025/0332553 A1
(43) Pub. Date: Oct. 30, 2025

(54) Robust Composite Membrane

(71) Applicant: Memzyme, LLC, Albuquerque, NM (US)

(72) Inventors: Laibao Zhang, Albuquerque, NM (US); Christopher P. Beamis, Mukilteo, WA (US)

(73) Assignee: Memzyme, LLC, Albuquerque, NM (US)

(21) Appl. No.: 18/645,801

(22) Filed: Apr. 25, 2024

(51) Int. Cl. B01D 69/14; B01D 53/22; B01D 67/00; B01D 69/10; B01D 71/02

(52) U.S. Cl. CPC B01D 69/144; B01D 53/228; B01D 67/0079; B01D 69/108; B01D 71/025; B01D 2256/10; B01D 2257/504

(57) ABSTRACT

Membranes, methods of making the membranes, and methods of using the membranes are disclosed herein. The membrane may include a mechanically stable porous support layer, a second porous layer consisting of preferentially ordered vertical channels, a third mesoporous layer consisting of top-hydrophilic bottom-hydrophobic nanoporous channel structures, and a thin liquid enzymatic layer remaining in the top-hydrophilic area of the third layer. The disclosed membranes may be used to separate carbon dioxide or other gases from gas mixtures.

### BACKGROUND

### Field of the Invention

The present disclosure relates generally to selectively permeable membranes and, more particularly, to robust and selectively permeable membranes configured to use catalysis to accelerate the selective permeation process.

### Description of the Related Art

Membranes are widely employed in gas filtration, liquid filtration, catalysis, and distillation applications. For example, membrane-based techniques are the most promising techniques for the capture and filtration of carbon dioxide (CO₂) from power plants. To meet the challenges of increasing CO₂ supplies for industrial use and re-use while also reducing greenhouse gas emissions, various approaches have been developed or proposed to separate and capture CO₂.

Researchers have spent decades trying to develop membranes for gas separation applications that demonstrate both high selectivity and high flux to satisfy the requirements of industrial gas separation applications. Commercial gas separation membranes consist mainly of polymeric materials. Such membranes have shown chemical resistance and stability, but lack the combination of high selectivity and high flux required for efficient separations. Also, such polymer-based materials are not as durable as inorganic membranes.

Another potential approach to gas separation employs enzymes in aqueous solution to catalyze the conversion of CO₂ to a water-soluble form to facilitate the uptake of CO₂ into solution, and then further catalyze the conversion of soluble CO₂ into the gas phase and thereby facilitate the release of CO₂. Neither enzymes in aqueous solution alone nor polymeric membranes, with or without enzymes, are feasible for gas separation because of their high cost, lack of high selectivity combined with high flux, and lack of durability.

CO₂ capture may be cost-effectively performed using an enzyme-laden water droplet in an ultrathin nanopore of an anodized alumina substrate. There is a need, however, for an improved membrane support to provide effective use of this system for industrial applications.

### SUMMARY

Membranes capable of selective permeation of CO₂ from one side to the other side of the membrane are disclosed herein. The separation is driven by a chemical potential gradient. The membrane is composed of a porous material as a base support layer to supply proper mechanical strength to the membrane; a second porous layer composed of ordered or non-ordered channels that can be attached onto the base support; a mesoporous layer attached to or embedded within the second porous layer that is composed of TiO₂, silica, alumina, or mixtures thereof and that has modified pore openings and/or modified surface chemistry to be hydrophobic on one side and hydrophilic on the other side; and a liquid enzymatic layer immobilized within the pores of the surface-modified mesoporous layer.

Methods of preparing the disclosed membranes are also disclosed herein. The membrane may be prepared by adhering a pre-formed enzyme layer, composed of a second porous layer and a third mesoporous layer that includes an enzymatic layer immobilized therein, to a base support layer.

Methods of using the disclosed membranes are also disclosed herein.

The base layer may be composed of a porous organic (e.g., polymer), inorganic (e.g., ceramic, metal, metal oxide), or composite material. The base layer may be in any arrangement configured to facilitate formation of a membrane suitable for use in a desired application. The base may be a flat disc, a tube, a spiral-wound structure, or a hollow fiber base.

The second porous material may have pores with diameters in the range of 5-200 nm. The thickness of the second porous layer may be a few microns, or may alternatively tens of microns. The porous channels may be ordered or non-ordered. In certain implementations, ordered mesoporous channels may be generated by anodization of alumina foil or alumina plates. The anodized aluminum oxide (AAO) may have a thickness of about 50 μm and may have oriented asymmetric vertical channels that are perpendicular to the surface. In some embodiments, the channel diameters taper from 200 nm at the bottom surface to 50-100 nm on the top surface.

In some implementations, the third mesoporous layer comprising TiO₂, silica, alumina, or mixtures thereof is attached to or embedded within the second porous layer. In some implementations, a sol-gel solution composed of one or more silica precursors, one or more surfactants, and one or more solvents is coated onto the second porous layer. After the sol-gel solution solidifies, the surfactant may be selectively removed to generate nanopores, thereby forming a nanoporous layer with a thickness of less than 10 μm. The nanoporous layer may include a hydrophilic layer and a hydrophobic layer.

The membrane structure may further include a liquid transport medium that resides within the hydrophilic layer, wherein the liquid transport medium includes a fluid-like permeation medium.

### BRIEF DESCRIPTION OF THE DRAWINGS

FIG. 1 shows an exemplary base support layer 1 in the form of a hollow tube.

FIG. 2 shows an exemplary second porous layer 2, having an outer surface 2A and an inner surface 2B that is in contact with the base support layer.

FIG. 3 shows silica sol filled mesopores 3 and silica nanopores 4 formed by calcination.

FIGS. 4A-4B show an exemplary ceramic base support layer in the form of a flat disc attached to a second porous layer in the form of an anodized alumina disc.

FIG. 5 shows gas permeation data for an exemplary pre-formed second porous layer in the form of a flat disc having an embedded third mesoporous layer.

### DETAILED DESCRIPTION

Exemplary embodiments of the disclosed membranes, methods of making the membranes, and methods of using the membranes are described herein. These embodiments should be understood as providing detailed examples of how the invention described herein may be implemented, but are in no way intended to limit the scope of the invention. The invention encompasses the embodiments described herein and all other embodiments within the scope of the claims.

The membranes may be composed of a base layer, a second porous layer, a third mesoporous layer, and a thin liquid enzymatic layer. The membranes may exhibit selective permeability to gases. For example, the membranes may be used to selectively remove CO₂ from gas mixtures containing hydrogen, oxygen, nitrogen, and CO₂. Further, the membranes may exhibit both high selectivity (expressed as gas permeance ratio, e.g., CO₂/N₂, CO₂/O₂, or CO₂/H₂) and high permeance.

The base layer may be composed of porous polymers, metal, metal oxides, ceramics, or composite materials. The material used to form the base layer may be selected based on the requirements of the application in which the membrane will be used. The base layer may be in any configuration that facilitates formation of a membrane suitable for use in a particular application, for example, a flat disc, a tube, a spiral-wound structure, or a hollow fiber. In some implementations, the support layer may be composed of a gas permeable polymer, which may be a cross-linked polymer, a phase separated polymer, or a blend thereof. Examples of suitable gas permeable polymers include polyolefins, polyamides, polyimides, polypyrrolones, polyesters, sulfone-based polymers, nitrile-based polymers, polymeric organosilicones, fluorinated polymers, copolymers thereof, or blends thereof. Inorganic fillers introduced into the polymer matrix may improve the mechanical strength thereof. In some implementations, the layer may include a fibrous material. The fibrous material in the base may be a mesh (e.g., a metal or polymer mesh), a woven or non-woven fabric, a glass, fiberglass, a resin, a screen (e.g., a metal or polymer screen), or another suitable material. In some implementations, the base may include a non-woven fabric (e.g., a non-woven fabric composed of fibers formed from a polyester). In some implementations, the support layer may be composed of zeolites, aluminum oxides, silica oxide, nickel, nickel alloy, titanium, stainless steel, or a combination thereof.

The second porous layer may be composed of porous polymers, metal oxides, or ceramics that have ordered or non-ordered porous structures. The well-ordered and vertically aligned nanochannels are preferred to allow most pores to be accessible. In some implementations, the second porous layer is a porous anodic aluminum oxide (AAO) with through-hole structure, which may be synthesized by electrochemical anodization of aluminum foils at −4-10° C. in aqueous acidic electrolytes and wet etching with CuCl₂ to remove barrier layers. The anodization electrolyte may be prepared by dilution of sulfuric acid, oxalic acid, citric acid, phosphoric acid, or a combination thereof. The pore diameters, porosity, symmetry, and channel length may be adjusted by anodization time, temperature, electrolyte concentration, current density/voltage, and thickness of aluminum samples. In some implementations, AAO with a hexagonal array of straight cylindrical pores and high porosities (>100 pores/cm²), tunable diameters (5-300 nm), and depths (10 nm-100 μm) may be attained by adjustment of anodization conditions using 0.3 M oxalic acid as an electrolyte.

The second porous layer may preferably be pre-formed and then attached to the base layer, thus improving the mechanical stability of the construct. By pre-forming the second porous layer and then attaching this pre-formed layer to the base layer, it is possible to maintain the performance of the pre-formed second porous layer with respect to selective gas permeability without compromising the robustness provided by the base layer. This allows the second porous layer to be constructed, tested, and optimized prior to attachment to the base layer, and thereby combines the efficiency of the optimized second porous layer with the robustness and commercial viability imparted by its attachment to the base layer. In addition, pre-forming the second porous layer provides additional flexibility in the design of the disclosed membranes, as may be desirable when the second porous layer is composed, for example, of a polymer.

The third mesoporous layer may be attached to or embedded within the pores of the second porous layer. Various materials, including nanoporous polymeric materials, may be used as the nanoporous layer. In some implementations, a mesoporous silica layer is fabricated by the “evaporation induced self-assembly” approach described by Brinker, et al. See Brinker, et al., Adv. Mater. 1999, 11(7), 579. The Pluronic P-123 block copolymer containing silica sol stays at the upper portion of the pores of the second layer due to capillarity, leaving pores at the bottom surface of the substrate unoccupied. The pore size and structure of the silica layer may be adjusted by changing the polymer type, polymer concentration, and silica precursor concentration. The porosity, pore size, and tortuosity of the layers derived from use of a sol-gel approach may be tailored by careful selection of template agents, changing template agent concentrations, changing pore surface chemistry of the second porous support, and/or removing surfactants with different treatment methods such as high temperature, plasma, ultraviolet radiation, solvents (e.g., isopropanol), or a combination thereof.

The third mesoporous layer may be further modified to be hydrophobic. In some implementations, hexamethyldisiloxane (HMDS) and/or trimethylchlorosilane (TMCS) may be used in the gas phase or liquid phase to render the silica pore surface hydrophobic. In other implementations, various structures may be inherently hydrophobic such that the hydrophobic surface treatment is optional. The top surface of the mesoporous channels may be subsequently changed to be hydrophilic by irradiation with an oxygen plasma, ozone treatment, ultraviolet light treatment, and/or atomic layer deposition (ALD). In some implementations, exposure to a mixed gas composed of O₂ and argon for 1-60 seconds is used to render the top surface hydrophilic. The hydrophilic portion may have a thickness of less than about 10 μm or less than about 20 nm. The thickness of the hydrophilic layer may be adjusted by treatment time and treatment intensity.

In some implementations, after the hydrophobic/hydrophilic treatment, the sample is soaked in a volume of the liquid solution of enzyme with the hydrophilic side facing the solution. As most parts of the prepared membrane are inherently hydrophobic with only the thin top layer being hydrophilic, the enzyme solution will remain only within the hydrophilic portion of mesopores of the third layer. Due to the small diameter of the mesopores of the third layer, capillary forces will promote uptake of the enzyme solution. The enzymes may be carbonic anhydrase (CA) enzymes or variants thereof. In some implementations, the enzyme may be commercially available bovine CA from cattle or synthetic CA from a thermophilic marine bacterium.

As described above, the second porous layer may be pre-formed before attaching said layer to the base layer. Thus, the third mesoporous layer may be embedded within the pores of the second porous layer and any further modifications or treatment of the third mesoporous layer may be made prior to attachment of the second porous layer to the base layer.

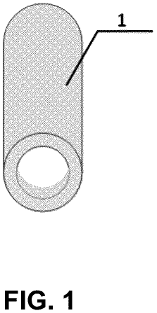

FIG. 1 shows an exemplary base support layer 1 in the form of a hollow tube.

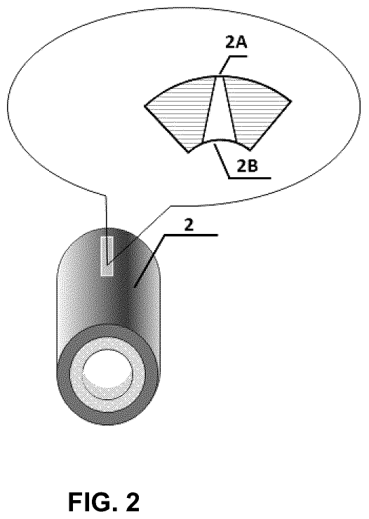

FIG. 2 shows an exemplary second porous layer 2, having an outer surface 2A and an inner surface 2B that is in contact with the base support layer.

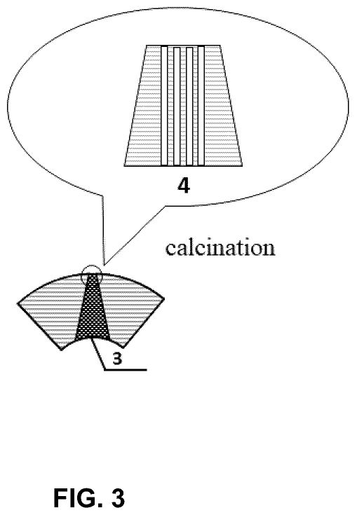

FIG. 3 shows silica sol filled mesopores 3 and silica nanopores 4 formed by calcination.

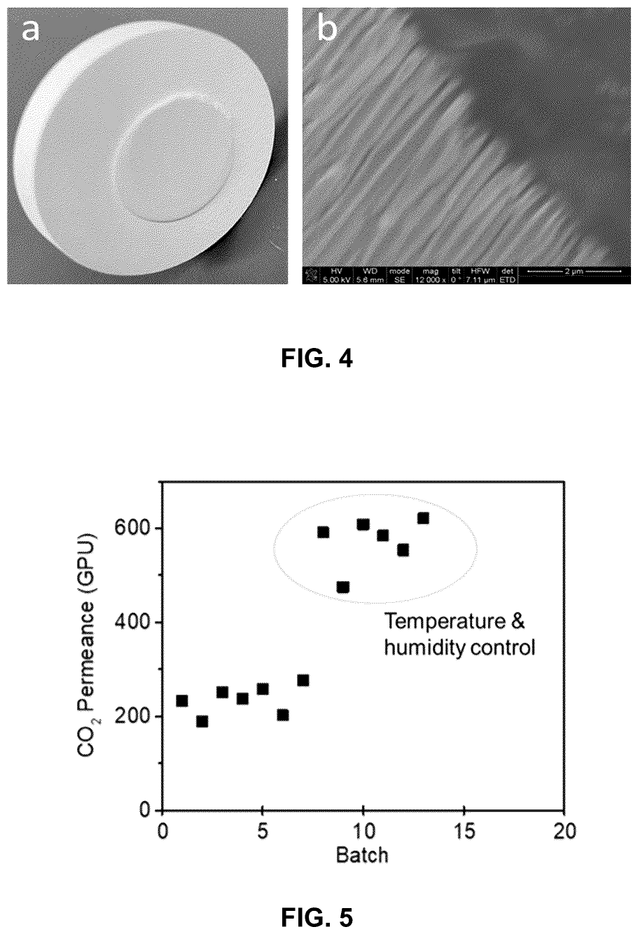

FIGS. 4A-4B show an exemplary ceramic base support layer in the form of a flat disc attached to a second porous layer in the form of an anodized alumina disc. Gas permeance remains nearly the same in the composite membrane as in the base support layer.

FIGS. 4A-4B show a composite membrane composed of a ceramic disc-supported commercial porous alumina (AAO, Whatman) membrane. Measured gas permeance in the robust composite (74,680 GPU) remains nearly as high as the pristine ceramic (94,208 GPU). FIG. 4A shows AAO bound firmly to a ceramic disc, creating a second porous layer attached to a robust base support. FIG. 4B shows a bottom cross-sectional view of an SEM micrograph of the bound second porous layer composed of AAO with a ˜200 nm pore diameter.

FIG. 5 shows gas permeation data for an exemplary pre-formed second porous layer in the form of a flat disc having an embedded third mesoporous layer.

CO₂ permeance was tested in the flat disc configuration for a pre-formed second porous layer and embedded third porous layer under different environments. Data in the circled area were collected at 32° C. with relative humidity varying from 55% to 91%. Other data were collected at room temperature with 50-60% relative humidity. Nitrogen permeance was negligible.

Methods for separating a first gas from a feed gas stream using the disclosed membranes is also described herein. The disclosed membrane directly contacts the feed gas stream that includes the first gas under conditions effective to afford transmembrane permeation of the first gas. The feed gas may be hydrogen, carbon dioxide, hydrogen sulfide, hydrogen chloride, carbon monoxide, nitrogen, oxygen, methane, methanol, higher hydrocarbons, steam, sulfur oxides, nitrogen oxides, or combinations thereof. In some implementations, the feed gas may be nitrogen and carbon dioxide, and the membrane exhibits >500 CO₂/N₂ selectivity at 32° C. and 5 psi feed pressure.

Methods of preparing the disclosed membrane are also disclosed herein. The methods include the step of depositing an enzyme layer, composed of the second porous layer and the third mesoporous layer that includes an enzymatic layer immobilized therein, on the base support layer. In some implementations, the porous AAO materials are attached to ceramic supports with ceramic adhesives or binders. Adhesives or binders for ceramic materials which leave a minimal amount of ash after calcination, easily burn out at low temperature, and readily disperse are preferred. Inorganic binders, including sodium silicate, magnesium aluminum silicate, bentonite, and organic binders, including polyvinyl alcohol, starches, carboxymethylcellulose, dextrin, polyethylene glycols, lignosulfonates, polyacrylates, paraffins and wax emulsions, may be used.

### NUMBERED EXAMPLES

Example 1. A method of fabricating a porous support configured to support a gas or liquid capture membrane, said method including the following steps:
(a) providing a base support layer;
(b) providing a pre-formed enzyme layer comprising a second porous layer and a third mesoporous layer,
   where the second porous layer has a top layer and pore structures,
   where the third mesoporous layer has a top surface sublayer and a bottom surface sublayer and has pore structures,
   where the surface chemistry of the pore structures of the third mesoporous layer is modified to make the top surface sublayer hydrophilic and the bottom surface sublayer hydrophobic and an enzymatic layer is subsequently introduced within the hydrophilic top surface sublayer of the third mesoporous layer; and (c) adhering the pre-formed enzyme layer to the base support layer.

Example 2. The method of Example 1, where the base support layer is composed of at least one of a ceramic material, metallic material, polymer material, or a composite.

Example 3. The method of Example 1, where the second porous layer is composed of at least one of anodized porous alumina, silica, ceramic, a polymer, a metal, a metal alloy, a metallic composite material, or a combination thereof.

Example 4. The method of Example 1, where the second porous layer is generated by anodization of metals.

Example 5. The method of Example 1, where the second porous layer is attached to the surface of the first substrate by adhesives.

Example 6. The method of Example 3, where the second porous material is anodized porous alumina.

Example 7. The method of Example 6, where the second porous material is attached to the surface of the first substrate by an adhesive.

Example 8. The method of Example 6, where the base support layer is composed of a ceramic material.

Example 9. The method of Example 7, where the base support layer is composed of a ceramic material.

Example 10. The method of Example 9, where the adhesive is selected from the group consisting of sodium silicate, magnesium aluminum silicate, bentonite, polyvinyl alcohol, starches, carboxymethylcellulose, dextrin, polyethylene glycols, lignosulfonates, polyacrylates, paraffins, and wax emulsions.

Example 11. The method of Example 1, where the third mesoporous layer is embedded within the second porous layer.

Example 12. The method of Example 3, where the third mesoporous layer is embedded within the second porous layer.

Example 13. The method of Example 6, where the third mesoporous layer is embedded within the second porous layer.

Example 14. The method of Example 9, where the third mesoporous layer is embedded within the second porous layer.

Example 15. The method of Example 1, where the enzymatic layer includes carbonic anhydrase (CA) enzymes or variants thereof.

Example 16. The method of Example 14, where the enzymatic layer includes carbonic anhydrase (CA) enzymes or variants thereof.

Example 17. The method of Example 16, where the adhesive is selected from the group consisting of sodium silicate, magnesium aluminum silicate, bentonite, polyvinyl alcohol, starches, carboxymethylcellulose, dextrin, polyethylene glycols, lignosulfonates, polyacrylates, paraffins, and wax emulsions.

Example 18. A gas or liquid capture membrane supported by a porous support to generate a support-membrane structure, said support-membrane structure including:
(a) a base support layer;
(b) a pre-formed enzyme layer that includes a second porous layer and a third mesoporous layer,
   where the second porous layer has a top layer and pore structures,
   where the third mesoporous layer has a top surface sublayer and a bottom surface sublayer and has pore structures,
   where the surface chemistry of the pore structures of the third mesoporous layer is modified to make the top surface sublayer hydrophilic and the bottom surface sublayer hydrophobic and an enzymatic layer is subsequently introduced within the hydrophilic top surface sublayer of the third mesoporous layer; and
where the pre-formed enzyme layer is adhered to the base support layer after the pre-formed enzyme layer is formed.

Example 19. A method of separating a first gas from a feed gas stream that includes the steps of:
(a) providing the support-membrane structure of Example 18, where the membrane is a gas capture membrane; and
(b) contacting the feed gas stream with the gas capture membrane to yield the first gas.

Example 20. The method of Example 19, where the feed gas stream is a mixture of nitrogen and carbon dioxide.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

1. A method of fabricating a porous support configured to support a gas or liquid capture membrane, said method comprising the following steps:
(a) providing a base support layer;
(b) providing a pre-formed enzyme layer comprising a second porous layer and a third mesoporous layer,
wherein the second porous layer has a top layer and pore structures,
wherein the third mesoporous layer has a top surface sublayer and a bottom surface sublayer and has pore structures,
wherein the surface chemistry of the pore structures of the third mesoporous layer is modified to make the top surface sublayer hydrophilic and the bottom surface sublayer hydrophobic and an enzymatic layer is subsequently introduced within the hydrophilic top surface sublayer of the third mesoporous layer; and
(c) adhering the pre-formed enzyme layer to the base support layer.

2. The method of claim 1, wherein the base support layer comprises at least one of a ceramic material, metallic material, polymer material, or a composite.

3. The method of claim 1, wherein the second porous layer comprises at least one of anodized porous alumina, silica, ceramic, a polymer, a metal, a metal alloy, a metallic composite material, or a combination thereof.

4. The method of claim 1, wherein the second porous layer is generated by anodization of metals.

5. The method of claim 1, wherein the second porous layer is attached to the surface of the first substrate by adhesives.

6. The method of claim 3, wherein the second porous material is anodized porous alumina.

7. The method of claim 6, wherein the second porous material is attached to the surface of the first substrate by an adhesive.

8. The method of claim 6, wherein the base support layer comprises a ceramic material.

9. The method of claim 7, wherein the base support layer comprises a ceramic material.

10. The method of claim 9, wherein the adhesive is selected from the group consisting of sodium silicate, magnesium aluminum silicate, bentonite, polyvinyl alcohol, starches, carboxymethylcellulose, dextrin, polyethylene glycols, lignosulfonates, polyacrylates, paraffins, and wax emulsions.

11. The method of claim 1, wherein the third mesoporous layer is embedded within the second porous layer.

12. The method of claim 3, wherein the third mesoporous layer is embedded within the second porous layer.

13. The method of claim 6, wherein the third mesoporous layer is embedded within the second porous layer.

14. The method of claim 9, wherein the third mesoporous layer is embedded within the second porous layer.

15. The method of claim 1, wherein the enzymatic layer comprises carbonic anhydrase (CA) enzymes or variants thereof.

16. The method of claim 14, wherein the enzymatic layer comprises carbonic anhydrase (CA) enzymes or variants thereof.

17. The method of claim 16, wherein the adhesive is selected from the group consisting of sodium silicate, magnesium aluminum silicate, bentonite, polyvinyl alcohol, starches, carboxymethylcellulose, dextrin, polyethylene glycols, lignosulfonates, polyacrylates, paraffins, and wax emulsions.

18. A gas or liquid capture membrane supported by a porous support to generate a support-membrane structure, said support-membrane structure comprising:
(a) a base support layer;
(b) a pre-formed enzyme layer comprising a second porous layer and a third mesoporous layer,
wherein the second porous layer has a top layer and pore structures,
wherein the third mesoporous layer has a top surface sublayer and a bottom surface sublayer and has pore structures,
wherein the surface chemistry of the pore structures of the third mesoporous layer is modified to make the top surface sublayer hydrophilic and the bottom surface sublayer hydrophobic and an enzymatic layer is subsequently introduced within the hydrophilic top surface sublayer of the third mesoporous layer; and
wherein the pre-formed enzyme layer is adhered to the base support layer after the pre-formed enzyme layer is formed.

19. A method of separating a first gas from a feed gas stream comprising:
(a) providing the support-membrane structure of claim 18,
wherein the membrane comprises a gas capture membrane; and
(b) contacting the feed gas stream with the gas capture membrane to yield the first gas.

20. The method of claim 19, wherein the feed gas stream is a mixture of nitrogen and carbon dioxide.
